(19) United States
(12) Patent Application Publication
(10) Pub. No.: US 2022/0275908 A1
(43) Pub. Date: Sep. 1, 2022

(54) METHOD FOR PRODUCING A PRESSURE CONTAINER AND PRESSURE CONTAINER

(71) Applicant: NPROXX B.V., Heerien (NL)

(72) Inventors: Dietmar Müller, Herford (DE); Frank Otremba, Stolberg (DE)

(21) Appl. No.: 17/637,573

(22) PCT Filed: Aug. 27, 2020
(86) PCT No.: PCT/EP2020/074009

§ 371 Date: Feb. 23, 2022

(30) Foreign Application Priority Data
Aug. 30, 2019 (EP) 19194566.6

(51) Int. Cl. F17C 1/06; F17C 1/08; B29C 70/32

(52) U.S. Cl. CPC F17C 1/06; F17C 1/08; B29C 70/32; F17C 2201/0104; F17C 2270/0168; F17C 2201/056; F17C 2203/012; F17C 2203/0604; F17C 2203/0621; F17C 2203/0663; F17C 2203/066; F17C 2203/0675; F17C 2203/0695; F17C 2205/0305; F17C 2209/2118; F17C 2209/2127; F17C 2209/2154; F17C 2209/219; F17C 2209/221; F17C 2209/224; F17C 2209/227; F17C 2209/232; F17C 2209/234; F17C 2221/012; F17C 2223/036; F17C 2260/013; B29L 2031/7156

(57) ABSTRACT

The invention relates to a method of manufacturing a pressure vessel and to a corresponding pressure vessel. The invention proposes a manufacturing method for a pressure vessel where first a pressure vessel blank having at least one liner type 4 and a cylindrical pipe operatively connected to it is manufactured and subsequently, for instance, a fibre composite material is wrapped onto the pressure vessel blank.

### FIELD OF THE INVENTION

The invention relates to a method of manufacturing a pressure vessel and to a respective pressure vessel.

### BACKGROUND OF THE INVENTION

The market for pressure vessels, in particular pressure vessels reinforced with fiber composite material, grows continually. Increasing production of natural gas and tracking gas makes storage in pressure vessels necessary, especially in countries without a corresponding pipeline network. In addition, the automotive industry which is heavily involved in the development of fuel cell vehicles requires that the fuel be stored in the form of gaseous hydrogen under high pressure in pressure vessels. Other types of vehicles using hydrogen may be railway vehicles, aircraft or watercraft. Even in spacecraft, application is conceivable. As regards the transport of the pressure vessels, it is desired that they should be light-weight pressure vessels because transporting heavy-weight pressure vessels is associated with the consumption of an unnecessarily high amount of energy, thus leading to excessively high transport costs.

Presently used cylindrical fibre-reinforced pressure vessels have a reinforcement layer consisting of fibre composite material made of fibres embedded in a matrix material which is wound onto an inner vessel (called liner) of the pressure vessel, which acts as a winding core, by means of a winding method. Winding is the preferred process for a manufacturing of fibre composite layers which is efficient in terms of time and costs. While the inner vessel guarantees, for instance, gas-tightness of the pressure vessel, the reinforcement layer made of fibre composite material provides the pressure vessel with the necessary mechanical rigidity. For pressure vessels of type 3, a metallic inner vessel (metallic liner) consisting e. g. of aluminum or steel is employed; in case of pressure vessels of type 4, the non-load-bearing inner vessel (liner) is made of plastic. The plastic liners are commonly produced by blow moulding, rotomoulding or welding of individual components. In particular, materials can be used which have good permeation properties with respect to hydrogen, such as polyamides or polyethylenes, in particular high-density polyethylene. The pressure vessels must withstand a very high inner pressure. Currently, for instance, hydrogen tanks of automobiles are filled at a pressure of approximately 700 bar. Especially, the pressure vessels may not burst, even in case of a crash. Therefore, such pressure vessels are designed with a cylindrical central part closed on both sides by what are called “pole caps”. To compensate for manufacturing tolerances, the reinforcement layers are accordingly oversized. The reinforcement layer can be manufactured, for instance, with the filament winding method, wherein the wrapping of the pressure vessels takes place in one single operation. In other words, the fibres are wound in one operation onto the plastic liner circumferentially or crosswise or in the form of helix layers.

This makes the manufacturing of such pressure vessels elaborate and expensive. Therefore, there is a desire to make the production more efficient.

### SUMMARY OF THE INVENTION

The object of the invention is to provide a manufacturing method for fibre-reinforced type 4 pressure vessels which can be performed more efficiently and inexpensively than the methods known in the state of the art, where at least the same requirements are made on the pressure vessel. Furthermore, it is an object of the invention to disclose a respective pressure vessel.

The first object is achieved by means of a manufacturing method in which first a pressure vessel blank, comprising at least one type 4 liner and a cylindrical pipe operatively connected to it, is produced and subsequently a fibre composite material, for instance, is wound onto the blank.

The term “pressure vessel” comprises all types and shapes of pressure vessels which comprise an inner vessel, also called liner. Type 4 pressure vessels comprise a liner made of a thermoplastic material which was mechanically reinforced by a fibre composite material on the outside such that the pressure vessel meets the requirements made in terms of pressure resistance. As a rule, these pressure vessels are cylindrical with convex terminals on both sides of the cylindrical central part. These terminals are called pole caps and are used for pressure-tight sealing of the central part. For reinforcement of the pressure vessel, an outer layer made of fibre composite material is wound onto the outside of the inner vessel, potentially forming at the same time the outside of the pressure vessel. The inner vessel can be produced by means of various techniques, for instance by welding, injection moulding or as a blow-moulded part. The pole caps can also be placed onto the central part after production, for instance by welding. The separate pole caps may be manufactured, for instance, by injection moulding. Pressure vessels with a thermoplastic inner vessel have a very low weight, on the one hand, which is important e. g. for applications in means of transport; and on the other hand, content such as hydrogen, for example, can be stored under high pressure with low losses since suitable thermoplasts have a sufficiently low hydrogen permeability and the required rigidity is provided by the outer layer made of fibre composite material.

In general, a fibre composite material for the fibre composite layer is composed of two main components, which are fibres herein, embedded in a matrix material which creates the strong bond between the fibres. Therein, the fibre composite material can be wound from one fibre or from a plurality of fibres, wherein the fibre(s) is/are wound closely next to and in contact with each other. The wound fibres are already impregnated with matrix material. This results in a fibre layer onto which additional fibres are wound in further fibre layers until the fibre composite material has the desired thickness and forms a corresponding fibre layer having this thickness. The outer layer is wound in several layers made of fibre composite material, where different layers may contain fibres arranged at different fibre angles with respect to the cylinder axis of the pressure vessel. In one embodiment, each of the fibre layers made of first and/or additional fibres, for instance second fibres, comprises a plurality of fibre layers. The composite gives the fibre composite material properties of higher quality, such as higher strength, than any of the two individual components involved could provide. The reinforcing effect of the fibres in the fibre direction is achieved when the modulus of elasticity of the fibres in the longitudinal direction is in excess of the modulus of elasticity of the matrix material, when the elongation at break of the matrix material is in excess of the elongation at break of the fibres and when the breaking resistance of the fibres is in excess of the breaking resistance of the matrix material. The fibres that can be used are fibres of any kind, for example glass fibres, carbon fibres, ceramic fibres, steel fibres, natural fibres, or synthetic fibres. The matrix materials used for the fibre composite layer are as a rule duromers. The material properties of the fibres and the matrix materials are known to the person skilled in the art, with the result that the person skilled in the art can select a suitable combination of fibres and matrix materials for producing the fibre composite material for the particular application. Herein, individual fibre layers in the fibre composite region can comprise a single fibre or a plurality of equal or different fibres.

The term “thermoplast” designates plastics which can be thermoplastically deformed within a specific temperature range. This process is reversible, that is, it can be repeated for an indefinite number of times by cooling and reheating into the molten state, provided that no thermal decomposition of the material takes place due to overheating. This distinguishes thermoplasts from duroplasts (or duromers) and elastomers. Another unique characteristic of thermoplasts is that they can be welded, in contrast to, for example, duromers.

The invention proposes to first manufacture a pressure vessel blank. In this manner, manufacturing of the pressure vessel blank is separated from manufacturing of the pressure vessel as a whole. Thus, the pressure vessel blank is produced separately. Here and in the following, “separate production” designates a production separate from, in particular in advance of, the actual production of the pressure vessel. The actual production of the pressure vessel takes place by winding, for instance, a fibre composite material onto the pressure vessel blank. By providing the pressure vessel blank separately, optimal conditions for production can be ensured, increasing efficiency and quality of this component and thus of the entire pressure vessel. Moreover, in this manner, the geometry of the pressure vessel is only determined by the prefabricated cylindrical pipes and no longer by the liner, thus increasing manufacturing precision in terms of length and of the diameter of the pressure vessel.

In detail, the production method can include the steps of manufacturing and processing of a pole cap reinforcement, manufacturing and processing of a cylindrical pipe, installation of a connecting piece (boss) in the liner, joining the cylindrical pipe and the pole caps with the liner, fixation of the positions of the cylindrical pipe and the pole cap reinforcements, for instance by punctual adhesive bonding, winding helix and circumferential layers consisting of a fibre composite material over the blank thus produced, and curing of the overall system.

In another advantageous embodiment, the cylindrical pipe is manufactured separately. This allows producing the pipe from various materials using the manufacturing method optimally suited for the respective material. In addition, manufacturing of the cylindrical pipe can be easily automated in this manner, further increasing the manufacturing efficiency.

In another advantageous embodiment, the cylindrical pipe is wrapped out of a fibre composite material. This material can be, for instance, a carbon fibre reinforced plastic (CFC). Components made of CFC are lightweight, on the one hand, but they also have a very high hardness. If the cylindrical pipe is made of a material of the same group which is later wrapped over the pressure vessel blank, this entails advantages in connecting the pressure vessel blank with the layer wrapped over it, increasing the overall hardness of the pressure vessel. By manufacturing the cylindrical pipe as a fibre composite component on a separate winding machine, wrapping speed and the number of fibres wrapped simultaneously can be increased. In this manner, the cylindrical pipe can also be produced from a different type of fibre than the rest of the pressure vessel. This can be an advantage for specific applications. Moreover, the cycle time of the actual vessel winding machine on which subsequently the pressure vessel is manufactured by winding the fibres on the pressure vessel blank, is substantially reduced. This is especially advantageous since due to its simple cylindrical geometry, the cylindrical pipe can be manufactured on a simpler and therefore less expensive winding machine than the pressure vessel. The pressure vessel has pole caps over which helical layers must be wrapped, whereas in one embodiment, the cylindrical pipe can only be produced by winding circumferential layers. In addition, by manufacturing the cylindrical pipe separately, different fibre angles can be introduced into the circumferential layers, or different types of fibres with different stiffnesses can be introduced into the product more easily than with conventional production.

Also, the cylindrical pipe can be manufactured with a lower wall thickness than the overall vessel, reducing the risk of fibre waviness and thus increasing resistance of the fibres.

In another advantageous embodiment, the cylindrical pipe is wound onto a metallic winding core. Deposition of the fibres can be performed more precisely on a metallic winding core than on a plastic liner. Use of the fibres can be improved in this manner. Moreover, a metallic winding core can be manufactured very precisely, which also allows a very precise production of the inner diameter of the cylindrical pipe or cylindrical semi-finished pipe wound thereon. This results in a reduction of manufacturing tolerances, which can in turn lead to an increase in the filling volume of the pressure vessel with equal assembly space.

In another advantageous embodiment, the cylindrical pipe is manufactured on a long winding core such that one winding results in several panels. In other words, first a cylindrical semi-finished pipe is wound from which the cylindrical pipe is cut to length. Especially if metallic winding cores are used, their hardness allows the winding of very long cylindrical semi-finished pipes. Winding of a particularly long cylindrical semi-finished product and cutting the same to length afterwards to produce metallic pipes further increases the efficiency of production. However, it is also possible to manufacture the cylindrical pipe on the winding core to final dimension by means of “board disks”, so that no cutting to length or other finishing process is necessary.

In another advantageous embodiment, the cylindrical pipe is, at the most, only partially cured. This makes it easy to handle and to work it mechanically, and during final curing after winding, it can produce a substance-to-substance bond with the winding. Here, as a rule, use of a partially cured pipe is to be preferred over a completely cured pipe, use of the latter, however, not being entirely excluded.

In another embodiment, the cylindrical pipe is extruded. This is a very economical manufacturing method. By means of extrusion, in particular, very long semi-finished pipes can be produced from which correspondingly cylindrical pipes can be cut to length. Especially long fibre-reinforced materials as well as duroplastic materials, however, cannot be extruded, such that for extrusion e.g. short fiber-reinforced thermoplasts, such as fibre-reinforced polyamides, can be used which, however, may entail disadvantages with respect to wrapped pipes in terms of hardness.

In another embodiment, the cylindrical pipe is pultruded. With pultrusion, materials can be processed which have longer fibres, even up to continuous fibres, than materials which can be processed with the extrusion method. Due to the longer fibres, the hardness of pipes thus manufactured with respect to extruded pipes can be increased.

In another advantageous embodiment, the liner has an outer geometry for receiving the cylindrical pipe such that the cylindrical pipe can positively engage with the liner. Especially if this positive engagement takes place at the transition from the cylindrical part of the pressure vessel to the pole caps, in particular if the pole caps have pole cap reinforcements, problems during cold filling can be avoided. If positive engagement takes place only on one side of the pressure vessel, the cylindrical pipe can be pushed onto the liner from the other side. If the outer geometry of the liner has a recess the cylindrical pipe can rest in, that is, if positive engagement takes place on both sides of the liner, the cylindrical pipe can be joined to the liner by a shrink process.

Normally, boss, liner and cylindrical pipe form one surface. The three components are then covered by wrapping together. In one embodiment, the cylindrical pipe can be in direct contact with the metallic boss. The plastic liner will then not be in direct contact with the reinforcement wrapping. In an alternative advantageous embodiment, a pole cap reinforcement is applied on at least one pole region of the liner before the pressure vessel blank is covered with wrapping. Like the pressure vessel blank, the pole cap reinforcement can also be manufactured separately, facilitating manufacturing of the pole cap reinforcement and thus achieving an optimum reinforcement effect. In this case, the cylindrical pipe is normally not in direct contact with the metallic boss.

In another advantageous embodiment, the cylindrical pipe is pressed onto the liner. By this method, a separately manufactured cylindrical pipe can be joined to a liner with undercuts which can positively engage with the cylindrical pipe. In addition, pressing allows the establishing of a biased connection between the liner and the cylindrical pipe, which may be advantageous in terms of possible formation of a gap between the liner and the cylindrical pipe in operation of the pressure vessel. Pressing may take place mechanically, for instance by the application of a partial vacuum to the interior of the liner. This causes temporary shrinkage of the liner diameter. The pipe can now be slid over the liner. When the partial vacuum is removed, the liner expands against the pipe interior.

In another advantageous embodiment, the cylindrical pipe is thermally joined to the liner. For this purpose, the liner can be cooled down substantially and/or the cylindrical pipe can be heated before joining. By cooling, the liner shrinks, that is, its diameter decreases. In the alternative process, the diameter of the cylindrical pipe increases during heating. When the temperatures equalize after joining, the shrink joint is produced.

In another advantageous embodiment, the cylindrical pipe is adhesively bonded to the liner. In this manner, an integral connection may be produced in addition to the shrink joint, which may minimize or even completely prevent formation of a gap between the liner and the cylindrical pipe during operation of the pressure vessel.

For adhesive bonding, it has proven advantageous if before bonding, the inner circumference of the cylindrical pipe is at least partially pretreated. This may be achieved, for instance, by a chemical pretreatment or a mechanical pretreatment. For example, the inner circumference of the cylindrical pipe can be roughened by abrasive methods. In this manner, the surface of the inner circumference of the cylindrical pipe is increased, which helps to achieve a stronger adhesive bond. Another example of such treatment is treatment by a laser.

Moreover, the surface of the inner circumference can be structured. This measure can help to carry off any gas that may enter between the liner and the cylindrical pipe, avoiding liner buckling.

Treatment of the inner circumference of the cylindrical pipe is only possible by the separate manufacturing thereof.

The invention furthermore relates to a pressure vessel manufactured with the method described above.

The embodiments listed above can be used individually or in any combination to implement the devices according to the invention, in deviation from the references in the claims.

### SHORT DESCRIPTION OF THE FIGURES

These and other aspects of the invention are shown in detail in the figures as follows.

FIG. 1: lateral section through a portion of a pressure vessel according to the invention

FIG. 2: lateral section through a portion of another pressure vessel according to the invention

### DETAILED DESCRIPTION OF EMBODIMENTS

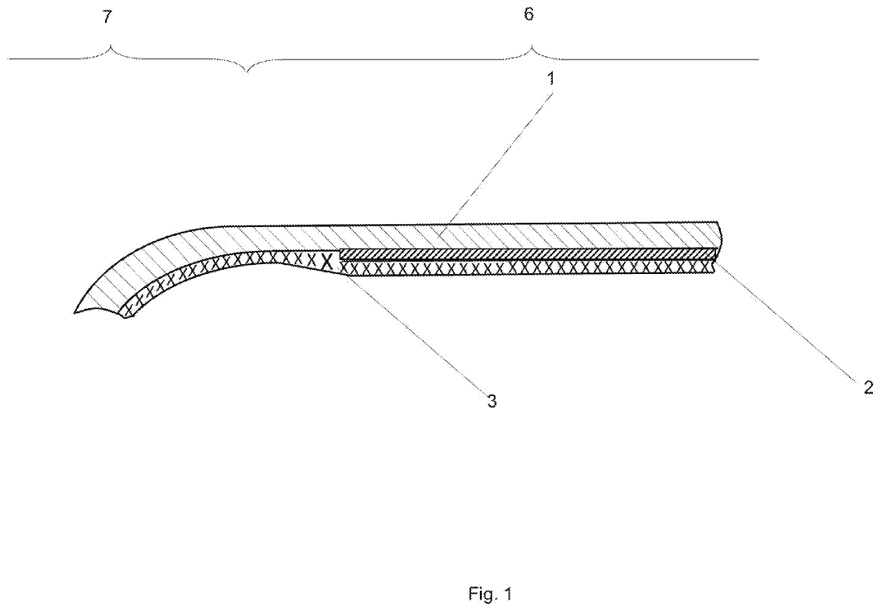

FIG. 1 shows a lateral section through a portion of a pressure vessel according to the invention. In particular, the Figure shows a section through the wall of a pressure vessel according to the invention. On its exterior, the pressure vessel wall has a winding 1 consisting of a fibre composite material. The winding 1 is applied on a pressure vessel blank, comprising a cylindrical pipe 2 and a liner as the inner layer. The cylindrical pipe 2 is located in the area of the cylindrical central portion 6 of the pressure vessel. The liner 3 has an outer geometry for receiving the cylindrical pipe 2 so that the cylindrical pipe 2 positively engages with the liner 3. This positive engagement is located at the transition from the cylindrical central portion 6 of the pressure vessel to the pole cap region 7. The outer geometry of the liner 3 has a recess the cylindrical pipe 2 rests against. The positive engagement can be such as to act in the axial and/or in the radial direction.

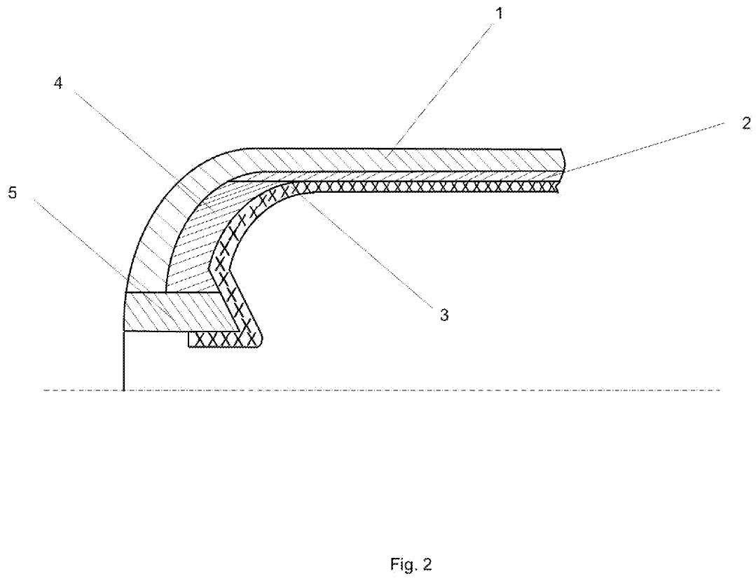

FIG. 2 shows a lateral section through a portion of a different pressure vessel according to the invention. The pressure vessel has a pole cap reinforcement 4 in the pole cap region 7 which is applied on the pole cap region 7 before the winding is applied on the pressure vessel blank. Like the pressure vessel blank, the pole cap reinforcement 4 can also be manufactured separately, facilitating production of the pole cap reinforcement 4 and allowing production of the pole cap reinforcement 4 such that an optimum reinforcing effect is achieved. A connection piece 5, also called boss, is inserted in the pole cap reinforcement 4 and the winding 1, which connection piece is used for filling the pressure vessel and for removing the content, for instance a gas. The boss 5 is inserted in the pressure vessel in such a way that the liner wraps around it. In the embodiment shown in FIG. 2, the liner 2 has no special outer geometry for receiving the cylindrical pipe 2, but is a standard liner with cylindrical outer geometry without any undercuts.

The embodiments shown here are only examples of the present invention and are therefore not to be understood as limiting. Alternative embodiments considered by the person skilled in the art are equally comprised by the scope of protection of the invention.

### LIST OF REFERENCE NUMBERS

winding
cylindrical pipe
liner type 4
pole cap reinforcement
boss
cylindrical central portion
pole cap region

1. A method of manufacturing a fibre-reinforced pressure vessel,
characterized by the following steps:
1) Manufacturing of a pressure vessel blank including at least one liner type 4 made of plastic, a cylindrical pipe operatively connected to it, a pole cap reinforcement and a boss,
2) Overwrapping of the pressure vessel blank.

2. The method according to claim 1,
wherein;
the cylindrical pipe is manufactured separately.

3. The method according to claim 2,
wherein;
the cylindrical pipe is wound from fibre composite material.

4. The method according to claim 3,
wherein;
the cylindrical pipe is wound on a metallic winding core.

5. The method according to claim 2
wherein;
the cylindrical pipe is cut to length from a cylindrical semi-finished pipe.

6. The method according to claim 2,
wherein;
the cylindrical pipe is wound to its final dimension.

7. The method according to claim 2,
wherein;
the cylindrical pipe is at most partially cured.

8. The method according to claim 2,
wherein;
the cylindrical pipe is extruded.

9. The method according to claim 2,
wherein;
the cylindrical pipe is pultruded.

10. The method according to claim 2,
wherein;
the liner has an outer geometry for receiving the cylindrical pipe such that the cylindrical pipe positively engages with the liner type 4.

11. The method according to claim 2,
wherein;
a boss is in direct contact with the cylindrical pipe.

12. The method according to claim 2
wherein;
before overwrapping of the pressure vessel blank, a pole cap reinforcement is applied on at least one pole region of the liner type 4.

13. The method according to claim 2,
wherein;
the cylindrical pipe is pressed onto the liner type 4.

14. The method according to claim 12,
wherein;
the cylindrical pipe is thermally joined with the liner type 4.

15. The method according to claim 2,
wherein;
the cylindrical pipe is adhesively bonded to the liner type 4.

16. The method according to claim 2,
wherein;
the cylindrical pipe is at least partially processed, at least on its inner circumference, before it is operatively connected to the liner type 4.

17. A pressure vessel,
wherein;
it is manufactured by a method according to claim 1.
